(19) United States
(12) Patent Application Publication
(10) Pub. No.: US 2008/0094372 A1
(43) Pub. Date: Apr. 24, 2008

(54) Touch Screen Element

(76) Inventor: Harald Philipp, Drogheda (IE)

Correspondence Address: DAVID KIEWIT, 5901 THIRD ST SOUTH, ST PETERSBURG, FL, 33705, US

(21) Appl. No.: 11/868,563

(22) Filed: Oct. 8, 2007

Related U.S. Application Data
(60) Provisional application No. 60/862,470, filed on Oct. 23, 2006.

(30) Foreign Application Priority Data
Oct. 19, 2006 (GB) 0620844.1

(51) Int. Cl. G06F 3/041

(52) U.S. Cl. 345/173

(57) ABSTRACT

A method of mounting a touch-screen element onto a control panel, and a corresponding assembled unit. In the assembled apparatus, the control panel has the touch-screen element mounted thereto. The touch-screen element comprises a sensing element mounted on a semi-rigid carrier, and first and second clamps for holding opposed sides of the touch-screen element to the panel. At least the second clamps is moveable between open and closed configurations, the open configuration being used during assembly. For assembly, one side of the touch-sensitive element is inserted into the first clamp. The touch-sensitive element is then bent into a curve and pushed down into the second clamp while the second clamp is in its open configuration. Once the touch-sensitive element has been flattened onto the panel and is in the second clamp, the second clamp is closed to complete the assembly.

### BACKGROUND OF THE INVENTION

The present invention relates to a method of mounting a touch-screen element onto a control panel and to an apparatus comprising a touch-screen element mounted onto a control panel.

The invention addresses a problem in mounting touch-screens of either the capacitive or surface-acoustic type to the rear of control panels. In the case of PC-monitor type touch-screens, usually it is acceptable to use the entire surface of the front cover sheet as a screen element, and so bonding or laminating a touch-screen layer to the back of the cover sheet is not a problem. The problem the invention seeks to solve occurs especially when the touch-screen size is less than the product panel size and only a subset area of the complete panel is desired to be made into a touch-screen. For example, in the case of a kitchen wall oven, hi-fi system, commercial coffee machine or similar appliance, bonding a touch-screen element to the rear of the panel over a display is difficult for the following reasons:
1. The bonding process usually involves a lamination step under the action of rolling pressure to prevent entrapment of air pockets. It is difficult and often impractical to run an entire panel through a laminating machine. Many control panels are not flat, for example a control panel may be injection molded with rear mounting bosses and other 3-dimensional features, which prevents insertion into a laminator without damage.
2. If the touch-screen proves to be defective after lamination, it is very difficult to remove the touch-screen again to facilitate replacement once the adhesive layer has cured in place. Furthermore, if the failure occurs in the field, no laminating machinery would be available to a service technician and the entire control panel would need to be replaced, which is a needlessly expensive and time-consuming operation.
3. Alignment of the sensing layer with respect to the rear panel surface is difficult even in a controlled environment since the pressure-sensitive adhesive (PSA) layer tries to adhere even before the laminating step begins, causing the operator to have to tear-up the layer from the panel surface and start again if the starting alignment is slightly wrong.

Additionally, it is difficult to market a touch-screen product for use behind larger panels where the touch area is much smaller than the overall panel, because manufacturing customers are generally more interested in a touch-screen product that can be readily assembled in production and where the assembly steps do not stress the sensing layer to the point where failures are possible. Lamination of Indium Tin Oxide (ITO) based films in particular is a stressful process that does lead to a certain failure rate, and as some control panels are extremely expensive, the lack of a non-stressful mounting process limits the marketability of ITO films alone.

The invention seeks to improve the mounting of rear-panel touch-screens by making the touch-screen element (TSE) insertable onto the panel without the need for a PSA between the TSE and the panel. Furthermore the invention allows the mounting of the TSE without tools or laminating machines, in a way that can be easily done by minimally trained operators. Furthermore the invention allows the easy replacement of a TSE in the field without requiring special tools or the need to replace the entire control panel.

### SUMMARY OF THE INVENTION

The present invention is based on the idea of using a semi-rigid carrier as part of the TSE, onto which the sensing element is pre-mounted via a separate lamination or deposition step. In the case of a capacitive type TSE, the sensing electrode layer is in one case a plastic layer having an Indium Tin Oxide (ITO) or similar resistive layer on a plastic film such as PET, with a PSA layer bonding one side of the PET to the carrier.

The carrier is preferably gently curved in one dimension to facilitate a positive contact along the panel surface once mounted. Two mounting clamps may be installed using an industrial grade adhesive to the back of the control panel, or, the control panel has in-built clamps formed during injection molding if the panel is made of plastic. The clamps are preferably positioned along the two opposing edges of the TSE along the axis of curvature. At least one clamp may be fashioned to allow the TSE to be inserted and clamped via a movable or insertable clamp lip. The TSE may be inserted into a first clamp on a first side of the TSE's final position, and the TSE may then be pushed down into a second clamp having a mounting lip. The lip is then clamped down in a final operation to secure the TSE to the panel under positive pressure.

Since the entire TSE-panel boundary is under positive pressure, there are no airgaps and the assembly is mechanically stable. A solution is provided also in the event of optical Newton's rings forming as a result of the boundary.

Thus, according to a first aspect of the invention there is provided an apparatus comprising: a panel; a touch-screen element mounted to the panel, the touch-screen element comprising a sensing element mounted on a carrier, and first and second clamp mechanisms for holding respective first and second edges of the touch-screen element to the panel; wherein the second clamp mechanism is moveable from an open configuration in which the touch-screen element can be fitted to the panel to a closed configuration in which the touch-screen element is held to the panel by the first and second clamp mechanisms.

Moreover, according to a second aspect of the invention there is provided a method of mounting a touch-screen element onto a control panel, the method comprising: providing a touch-sensitive element having first and second edges; providing a control panel having a boundary surface to which the touch-sensitive element is to be mounted; providing the control panel with first and second clamp mechanisms for holding the first and second edges of the touch-screen element to the control panel, wherein the second clamp mechanism is in an open configuration; inserting a first edge of the touch-sensitive element into the first clamp mechanism; bending the touch-sensitive element into a curved shape so that its convex side faces the boundary surface; pushing the second edge of the touch-sensitive element downwards into the second clamp mechanism so that the touch-sensitive element lays flat against the boundary surface; and moving the second clamp mechanism into a closed configuration to hold the touch-sensitive element in the panel.

Thus a pre-made touch-screen element can be readily mounted to a panel of an apparatus using simple mechanical fastenings and without requiring a separate lamination step at product assembly stage. Furthermore, the touch-screen element can be easily removed, e.g. for repair or replacement.

The moveable second clamp mechanism may comprise a base part and a moveable part, wherein the base part is fixed to the panel and the moveable part is moveable between a mated position in which the moveable part is mated to the base part and a non-mated position in which the moveable is not mated to the base part, wherein the moveable part includes a protrusion adapted to hold the touch-screen element to the panel when in the mated position. This arrangement provides for a simple mechanical clamp mechanism that is easy to operate.

The moveable part may be linked to the base part by a hinge section, and the base part and the movable part may have cooperating mating surfaces arranged to latch together when in the mated position. This provides for an easy to manufacture and operate clamp mechanism. Furthermore, the base part may include a slide-prevention protrusion adjacent the panel and extending beyond the base part's mating surface to abut the touch-screen element in its mounted position. This helps align and maintain the touch-screen element in position while allowing the mating surface to be spaced away from the edge of the touch-screen element to allow for easier mounting.

The protrusion adapted to hold the touch-screen element to the panel when in the mated position may be deformable. This can help ensure the touch-screen element is biased in position when mounted to the panel.

In other embodiments, the moveable part may be a removable insertion part having a lip assembly for providing the protrusion adapted to hold the touch-screen element to the panel and configured so that when a tongue of the insertion part is inserted into a channel of the base part the lip assembly holds the touch-screen element to the panel. This arrangement provides for another simple mechanical clamp mechanism that is easy to operate.

The tongue of the insertion part and the channel of the base part may be structured so as to facilitate a friction fit between them, e.g. the tongue of the insertion part and the channel of the base part may comprise respective grooves configured to mate with one-another.

The lip assembly may include a compliant element, e.g. an extruded rubber profile, configured to compress against the touch-screen element when the insertion part is mated to the base part. This can also again ensure the touch-screen element is biased in position when mounted to the panel.

The base part of the second clamp mechanism may be fixed to the panel, e.g. by an adhesive, or may be integrally formed with the panel.

Similarly, the first clamp mechanism may be fixed to the panel, e.g. by an adhesive, or may be integrally formed with the panel.

The first clamp mechanism may be a non-movable clamp mechanism, e.g. a simple fixed-lip type clamp, possibly with a resilient element for biasing the touch-screen element against the panel. Alternatively, the first clamp mechanism may be a movable clamp mechanism similar to, or the same as, the second clamp mechanism.

The respective first and second edges of the touch-screen element may be opposing edges.

The touch-screen element may in its free state (i.e. when not clamped in position) have a curved shape with a convex side thereof facing the panel so that a surface of the touch-screen element is biased against a surface of the panel when the touch-screen element is mounted to the panel. This can help ensure a good contact between the touch-screen element and the panel over the full extent of the touch-screen element. Likewise, a surface of the panel may have a curved shape such that a surface of the touch-screen element is biased against the surface of the panel when the touch-screen element is mounted to the panel.

The apparatus may further comprise alignment strips fixed to the panel at locations adjacent edges of the touch-screen element other that the first and second edges which are clamped. This can help align and prevent movement of the touch-screen element relative to the panel along directions parallel to the extent of the clamped edges.

The apparatus may further comprise an index matching fluid or anti-reflecting coating between the touch-screen element and the panel. This can reduce optical interference effects, such as Newton's rings.

The apparatus may further comprise a display module arranged so that the touch-screen element is positioned over a display of the display module.

### BRIEF DESCRIPTION OF THE DRAWINGS

For a better understanding of the invention and to show how the same may be carried into effect, reference is now made to the accompanying drawings in which:

FIG. 1A shows a control panel having a control surface, button areas, and a touch-screen composed of an LCD or other display type along with a TSE mounted behind the panel and in front of the display module.

FIG. 1B shows a cross-section of the control panel of FIG. 1A taken along line a-a.

FIG. 1C shows an enlargement of the TSE area of FIG. 1B.

FIG. 2 shows one type of clamp mechanism in perspective view, shown cross-section in FIG. 1C.

FIG. 3A shows a second type of clamp mechanism in cross-section, in an open configuration.

FIG. 3B shows the clamp mechanism of FIG. 3A in perspective view, in a closed configuration.

FIG. 4 shows the second type of clamp mechanism in cross-section, in an open configuration, with a curved TSE inserted into an opposing clamp.

FIG. 5 shows the rear of the panel of FIG. 1A with a TSE fully inserted and clamped.

FIG. 6A shows a cross-section of a capacitive version of the TSE.

FIG. 6B shows the user-side of a capacitive version of the TSE of FIG. 6A.

### DETAILED DESCRIPTION OF THE INVENTION

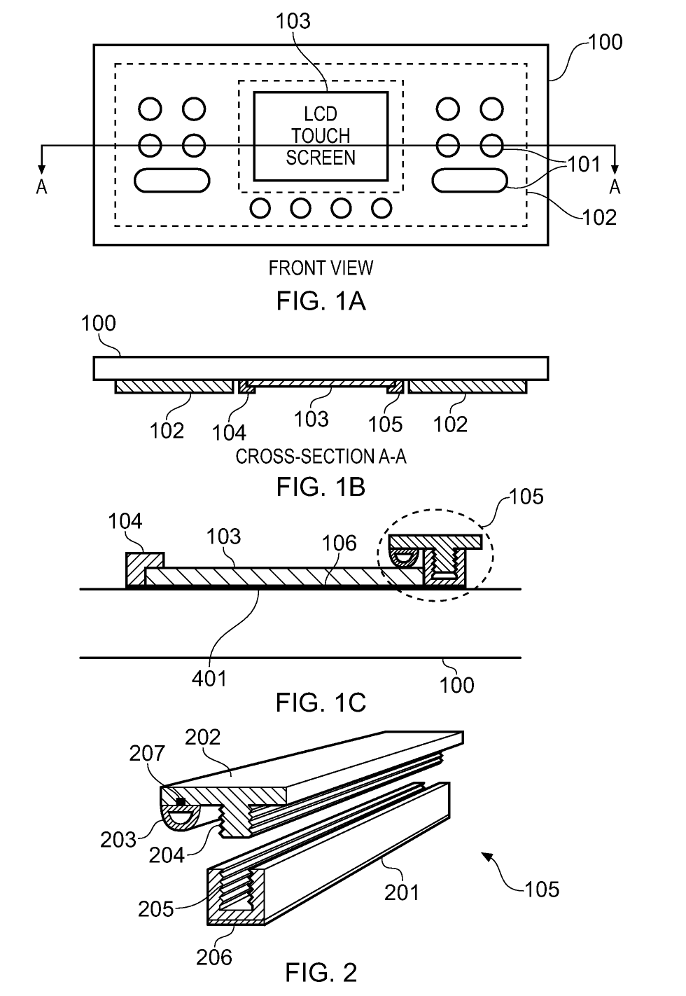

Turning now to FIG. 1A, a control panel piece 100 is shown from the user-side. Dotted lines 102 show the outline of a PCB which has been adhered to the back of 100 with its own PSA layer. This PCB may contain touch control circuitry and electrodes for controlling buttons 101, of which there are fourteen shown, as well as a connection point to the TSE 103. PCB 102 is optional and is not required for the invention but is included to illustrate a typical application involving a combination of a TSE with discrete touch buttons on the same panel. Buttons 101 may also be of a mechanical type, and in any event are not important to the invention.

FIG. 1B shows a cross-section of FIG. 1A taken along line a-a, including strip clamps 104 and 105 which hold the TSE in place. For graphic simplicity 105 is not shown in detail in FIG. 1B, but is detailed instead in FIG. 1C.

FIG. 1C shows a non-moveable strip clamp 104 on a first edge of the TSE 103, and a second strip clamp with a removable lip assembly, 105. Clamp 104 holds the TSE pressed against the panel on a first edge. The second edge of TSE 103 is held in place by clamp assembly 105. The sensing layer of the TSE is a thin layer 106; in the case of an ITO based capacitive element, layer 106 comprises an ITO layer and possibly a PET substrate with a PSA as will be described later. The boundary between the TSE and the panel 100 is shown as 401.

FIG. 2 shows in further detail one type of clamp 105, it being composed of two parts, fixed base part 201 and insertion part 202. Part 201 is fixed to the rear of panel 100 by means of an adhesive 206. A channel 205 is structured in a way as to capture part 202, for example by using grooves along the sides of the channel to facilitate a friction fit. Part 202 has a tongue 204 which also has grooves that mate with the grooves lining channel 205, so that when inserted, the piece 202 cannot come loose without manual removal.

On the underside of one surface of part 202 is a compliant profile of material 203, which is used to compress gently against the TSE 103 when 202 is mated into base 201. Material 203 can be made of extruded rubber and should be adhered to 202 as shown, possibly using adhesives or via a mechanical fit into a channel 207 in 202.

Base strip 206 and fixed strip 104 can be readily mounted using a simple alignment fixture in production. They do not need to be laminated down, and little training is required to mount these strips as they are relatively non-critical as to air pockets between them and the panel, since these strips are outside the viewing area of the display.

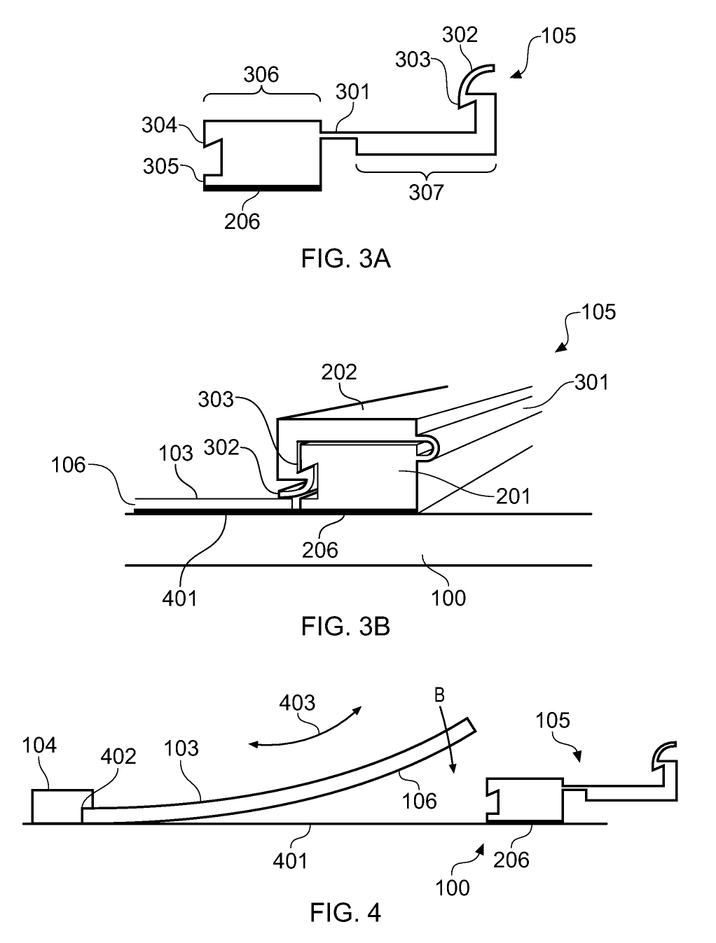

FIG. 3A shows a different type of strip clamp 105, being comprised of a single profile of extruded plastic with a hinge portion 301. Portion 306 is the fixed base portion. An adhesive 206 is used to mount 306 to the back of the panel as before. The portion 307 is movable, it being linked to base portion 306 with a thin, bendable hinge area 301. Mating clamp surfaces 303 and 304 capture each other when the portion 307 is bent and closed. A thin flexible portion 302 protruding from portion 307 acts to press gently down on the TSE 103 when portion 307 is closed onto portion 306.

FIG. 3B shows the clamp 105 in closed position, holding down a TSE 103 on its second edge. Mating surfaces 303 and 304 are latched making unintended opening of the mechanism very difficult. The hinge 301 is bent through nearly 180 degrees, and acts to capture the right side of 307 (as shown) to prevent it from separating from base portion 306. Protrusion 305 of the portion 306 acts to space the TSE 100 properly so that the TSE cannot slide very much or at all to the right (as shown). As the TSE needs to clear the latch area 304 on assembly, without 305 there would be a pronounced gap between the second edge of 103 and the base of 306, which could result in positional errors in assembly. Protrusion 305 acts to locate the second edge of the TSE without a significant gap which could result in displacement errors. Thin pressure strip 302 is slightly deformed, enough to gently push TSE 103 down flat on the inside of panel 100 along boundary 401.

FIG. 4 shows the assembly process of the invention with clamp 105 open. As shown, the TSE 103 is curved (exaggerated for illustration purposes) along path 403, the convex side thereof facing boundary surface 401. The sensing layer is shown again as 106, on the panel side of the TSE. The TSE first edge is first inserted into fixed strip clamp 104 as shown. The operator then pushes the second side of the TSE downwards into the strip clamp 105 (arrow B) so that the TSE lays flat against the interior surface of panel 100, along boundary 401. When the strip clamp 105 is closed, the final fit is as shown in FIG. 3B.

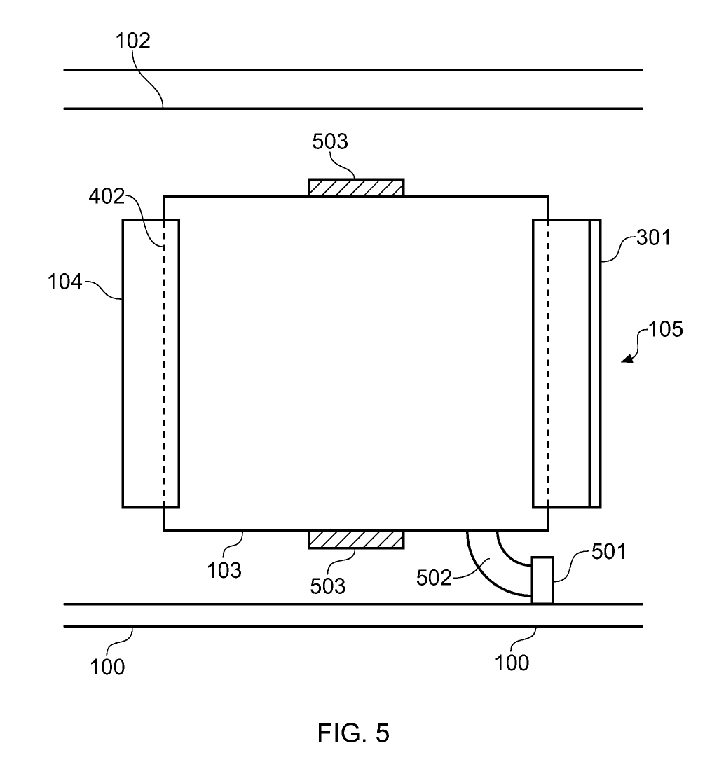

FIG. 5 shows a plan view of the rear of the control panel 100, with TSE 103 flattened against the panel 100 by strip clamps 104 and 105. Hinge surface 301 can also be seen. Strip clamps 104 and 105 can either be the entire length of the edges of TSE 103, or only a portion thereof as shown. Also shown in FIG. 5 are two alignment strips 503 which are used to align the TSE in position along the vertical axis (as shown) and to prevent vibration or shock from moving the TSE along the vertical axis. These strips 503 are simple profiles and are not further detailed, but may be rectangular, L-shaped, or other as may suit the designer. They may run the full length of their respective edges or a portion thereof as shown.

While the four elements 104, 105, and 503 are shown as separate pieces, it is perhaps desirable to make these into one injection moulded frame which can hold the TSE 103. While the tooling for such a piece would cost more money than the tooling for a set of extrusion profiles, and the resulting part would only accommodate one size of TSE, it might nevertheless be advantageous for assembly reasons to make these four elements into one unitary ‘frame’ which would align and hold the TSE in place. Alternatively these four elements can be incorporated directly into the panel 100 itself, for example if the panel is made of injection moulded plastic, so that the only assembly step is the insertion of the TSE into the frame which is already provided by the panel itself. This method would be suitable especially for high volume consumer electronic devices, where the extra labour steps of mounting and adhering the strips would be prohibitive.

Since the elements 104, 105 and 503 are not within the visible area of the display, the bonding of these pieces (or single piece in the case of a unitary injection moulded part) can be facilitated with a curable liquid or gel adhesive that permits the piece(s) to move into alignment during assembly. After the piece(s) are aligned, the adhesive can be cured via time, heat or UV light to fix them (it) in place before inserting the TSE 103. Other methods of mounting include heat-staking, ultrasonic welding, screwing into bosses, and mechanical interference snap-fitting among others. The use of an adhesive to mount the strips as described supra is not to be taken as limiting to the invention. Mounting of the PCB 102 (if used) can be either before or after mounting of the strip clamp assemblies.

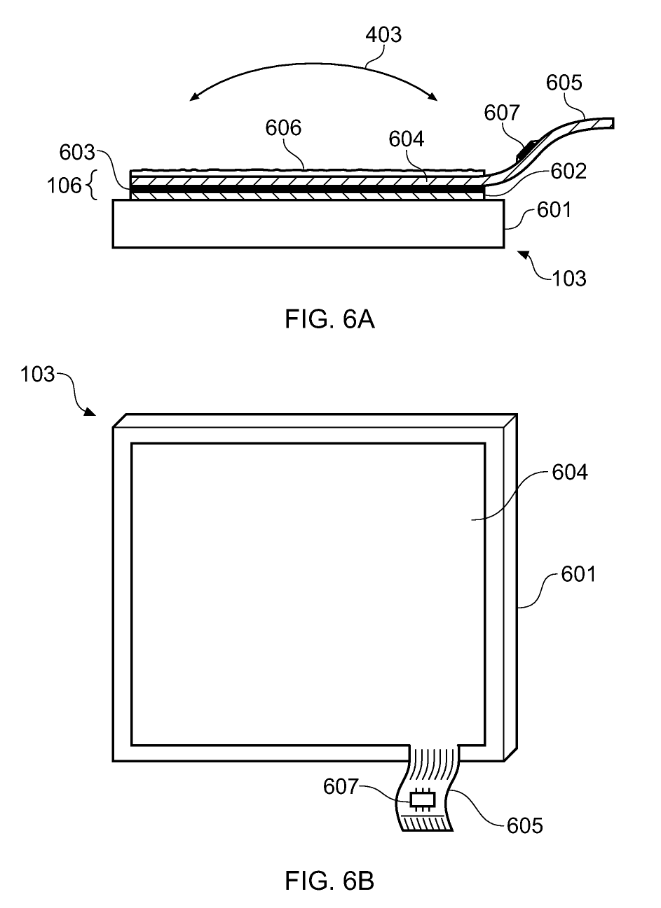

FIG. 6A shows a flat cross-section of TSE 103. Semi-rigid layer 601 may be made of a clear, thin but relatively hard plastic, for example 1.5 mm of polycarbonate. A flexible film layer 604 made of clear plastic such as PET on which is deposited the ITO sensing layer 603 (in the case of a capacitive screen) is bonded to the semi-rigid layer 601 via means of an adhesive layer 602. Since this assembly is small, this adhesive bonding process is easy to control and can be performed by a touch-screen manufacturer. The complete assembly 103 should be tested prior to shipment to the customer, ensuring that the lamination step did not induce a failure in the sensing elements.

While FIG. 6A shows the TSE 103 as flat, in fact a preferable shape is slightly curved along one direction 403 as shown first in FIG. 4, to allow positive mating of the surfaces along boundary 401 as explained supra; the upper surface of the assembly of FIG. 6A is the surface which is mated to the panel 100. The curvature can be induced either before or after the lamination step by means of heating the layer 601 and applying pressure to cause it to take a curve. It is preferable to induce the curvature before laminating so that the sensing layer is always under compression rather than tension, to reduce the chances of sensing element breakage.

FIG. 6B shows a plan view of a capacitive version of the TSE 103 with the sensing layer 604 affixed to one side. An electrical tail 605 connects this film to the electronics contained on a separate PCB; in some embodiments, the electronics 607 are mounted on the tail itself or near an edge of the film to provide a complete, standalone touch-screen module. The tail 605 should emerge from the TSE panel in an area not occupied by clamp strips or alignment strips 104, 105, 503. The side on which film 604 is mounted is the side that is convex (if curved) and mounted to face panel boundary 401.

In some cases, the mounting of the TSE 103 to a panel can cause Newton's rings. The phenomenon of Newton's rings is an interference pattern caused by the reflection of light between two adjacent surfaces which are not perfectly flat against each other. While the flattening of the TSE against boundary 401 should generally eliminate Newton's rings, some residual effects might be observed in some cases where good co-planarity cannot be achieved. To overcome this, it would be desirable to apply a thin layer of index matching fluid on surface 604, such as an oil or gel 606. Alternatively layer 606 can be a deposited anti-reflective (AR) layer which will sufficiently attenuate any Newton's rings.

In an alternative embodiment, the underside of the control panel 100 defined by boundary 401 may itself be curved so that the curvature of TSE 103 may be less significant compared to earlier described embodiments in order to make an optimum positive contact between the control panel 100 of a device and the TSE 103. Curvature of one or other, or both, of the control panel and the TSE beneficially improves the pressure applied to create a positive contact or bond between the control panel and the TSE thereby helping to eliminate any air bubbles which may be present in the boundary region 401.

A particular advantage of the invention is the provision of an apparatus and a method for easily mounting a touch-screen element to the rear of a control panel of a device. Furthermore, the touch-screen element can easily be removed from the control panel for replacement after its lifetime. This means that the whole device does not need to be replaced if the touch-screen element fails or becomes defective. Currently, most devices with control panels incorporating touch-screens require the whole device to be replaced if the touch-screen element breaks.

Although the present invention has been described with respect to preferred embodiments, many modifications and alterations can be made without departing from the invention. Accordingly, it is intended that all such modifications and alterations be considered as within the spirit and scope of the invention.

Thus an apparatus is described comprising a control panel having a touch-screen element mounted to a surface of the panel. The touch-screen element comprises a sensing element mounted on a semi-rigid carrier, and first and second clamp mechanisms for holding respective first and second edges of the touch-screen element to the panel. One or both of the clamp mechanisms is moveable from an open configuration to a closed configuration. In the closed configuration, the touch-screen element is held to the panel by the clamp mechanisms, and in the open configuration the touch-screen element not held to the panel. The moveable clamp mechanism may comprise a base part fixed to the panel and a cooperating movable part having a protrusion for holding the touch-screen element to the panel, wherein the moveable part may be moved between a mated (latched) position in which the protrusion holds the touch-screen element to the panel and a non-mated (un-latched) position in which the moveable is not mated to the base part and the touch-screen element is free to be moved away from the panel.

What is claimed is:

1. Apparatus comprising:
a panel;
a touch-screen element mounted to the panel, the touch-screen element comprising a sensing element mounted on a carrier, and
first and second clamp mechanisms for holding respective first and second edges of the touch-screen element to the panel; wherein the second clamp mechanism is moveable from an open configuration in which the touch-screen element can be fitted to the panel to a closed configuration in which the touch-screen element is held to the panel by the first and second clamp mechanisms.

2. Apparatus according to claim 1, wherein the second clamp mechanism comprises a base part and a moveable part, wherein the base part is fixed to the panel and the moveable part is moveable between a mated position in which the moveable part is mated to the base part and a non-mated position in which the moveable is not mated to the base part, wherein the moveable part includes a protrusion adapted to hold the touch-screen element to the panel when in the mated position.

3. Apparatus according to claim 2, wherein the moveable part is linked to the base part by a hinge section.

4. Apparatus according to claim 2, wherein the base part and the movable part have cooperating mating surfaces arranged to latch together when in the mated position.

5. Apparatus according to claim 2, wherein the protrusion adapted to hold the touch-screen element to the panel when in the mated position is deformable.

6. Apparatus according to claim 4, wherein the base part includes a slide-prevention protrusion adjacent the panel and extending beyond the base part's mating surface.

7. Apparatus according to claim 2, wherein the moveable part is a removable insertion part having a lip assembly for providing the protrusion adapted to hold the touch-screen element to the panel and configured so that when a tongue of the insertion part is inserted into a channel of the base part the lip assembly holds the touch-screen element to the panel.

8. Apparatus according to claim 7, wherein the tongue of the insertion part and the channel of the base part are structured so as to facilitate a friction fit between them.

9. Apparatus according to claim 7, wherein the tongue of the insertion part and the channel of the base part comprise respective grooves configured to mate with one-another so as to facilitate a friction fit between them.

10. Apparatus according to claim 7, wherein the lip assembly includes a compliant element configured to compress against the touch-screen element when the insertion part is mated to the base part.

11. Apparatus according to claim 2, wherein the base part of the second clamp mechanism is fixed to the panel by an adhesive.

12. Apparatus according to claim 2, wherein the base part of the second clamp mechanism is integrally formed with the panel.

13. Apparatus according to claim 1, wherein the first clamp mechanism is fixed to the panel by an adhesive.

14. Apparatus according to claim 1, wherein the first clamp mechanism is integrally formed with the panel.

15. Apparatus according to claim 1, wherein the second clamp mechanism is moveable from its closed configuration to its open configuration, thereby providing a releasable mechanism.

16. Apparatus according to claim 1, wherein the respective first and second edges of the touch-screen element are opposing edges.

17. Apparatus according to claim 1, wherein the touch-screen element has a curved shape with a convex side thereof facing the panel so that a surface of the touch-screen element is biased against a surface of the panel when the touch-screen element is mounted to the panel.

18. Apparatus according to claim 1, wherein a surface of the panel has a curved shape such that a surface of the touch-screen element is biased against the surface of the panel when the touch-screen element is mounted to the panel.

19. Apparatus according to claim 1, further comprising alignment strips fixed to the panel at locations adjacent edges of the touch-screen element other that the first and second edges.

20. Apparatus according to claim 1, further comprising an index matching fluid or anti-reflecting coating between the touch-screen element and the panel.

21. Apparatus according to claim 1, wherein the sensing element is laminated onto the carrier.

22. Apparatus according to claim 1, wherein the sensing element is mounted to the carrier using a pressure sensitive adhesive

23. Apparatus according to claim 1, further comprising a display module arranged so that the touch-screen element is positioned over a display of the display module.

24. A method of mounting a touch-screen element onto a control panel, the method comprising:
providing a touch-sensitive element having first and second edges;
providing a control panel having a boundary surface to which the touch-sensitive element is to be mounted;
providing the control panel with first and second clamp mechanisms for holding the first and second edges of the touch-screen element to the control panel, wherein the second clamp mechanism is in an open configuration;
inserting a first edge of the touch-sensitive element into the first clamp mechanism;
bending the touch-sensitive element into a curved shape so that its convex side faces the boundary surface;
pushing the second edge of the touch-sensitive element downwards into the second clamp mechanism so that the touch-sensitive element lays flat against the boundary surface; and
moving the second clamp mechanism into a closed configuration to hold the touch-sensitive element in the panel.
